(19) United States
(12) Patent Application Publication
(10) Pub. No.: US 2003/0175375 A1
(43) Pub. Date: Sep. 18, 2003

(54) Device for injection moulding

(76) Inventors: Werner Bodmer, Haslach (DE); Rainer Armbruster, Wolfach (DE)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(21) Appl. No.: 10/332,763

(22) PCT Filed: Jul. 10, 2001
(86) PCT No.: PCT/EP01/07930

(30) Foreign Application Priority Data
Jul. 12, 2000 (CH) 1373/00

(51) Int. Cl. B29C 45/76

(52) U.S. Cl. 425/155; 425/162

(57) ABSTRACT

The invention relates to a device for the injection moulding of materials. Said device comprises an injection moulding machine (40) and at least one mould (20, 21) which can be actively connected thereto. The injection moulding machine comprises a standardised interface element (1) which can be actively connected to a corresponding interface element (1) pertaining to more than one mould (20, 21). Means such as substances, energy, and information are exchanged with the at least one mould (20, 21) via the interface part (1).

The invention lies in the field of moulding technology, in particular in the field of injection moulding technology of plastics according to the preamble of the independent patent claim.

Devices for injection moulding plastics are known from the state of the art. They consist of an injection moulding mould (hereinafter mould) and an injection moulding machine on which the mould is fastened. One requires an individual, mould of a greater or lesser complexity for each part to be manufactured.

As a rile, the injection moulding machines are designed such that they may be applied for various moulds. In order however to change a mould one requires lengthy procedures. At the same time the moulds must be positioned and aligned. Subsequently a time-consuming setting of the parameters is effected which as a rule demands a considerable expense of time and material.

Flexibility and a quick reaction capability are of particular importance with today's manufacturing processes. In particular with manufacturing processes where different parts are manufactured it is therefore of a disadvantage if many resources are lost when changing a mould.

It is the object of the invention disclosed here to specify a device which effects a considerable simplification of a manufacturing process, permits a more flexible production, saves resources and makes cost advantages possible.

This object is achieved by the device defined in the patent claims.

The invention disclosed here amongst other things is based on intelligent interfaces between moulds and injection moulding machines (for example transition module from the mould to the injection moulding machine). By way of a standardisation of interfaces for transfer of media such as cooling fluids (water, gas, oil), hydraulics, electrical and mechanical energy as well as information and signals, it is possible to coordinate moulds and injection moulding machines to one another in a manner such that a change in a manufacturing process is possible in a very short time. The interfaces are defined such that they may be suitably combined for several moulds.

A preferred embodiment form of the invention consists of a device for injection moulding materials. This consists for example of an injection moulding machine and one or more moulds which are actively connectable to this. The injection moulding machine at the same time comprises a standardised interface part which may be actively connected to a corresponding standardised interface part of one or more moulds. One or more means such as media, energy, information are exchanged between the injection moulding machine and a mould via this standardised interface part.

The used moulds preferably comprise means for storing information. With this it is for example the case of microprocessors, memory units, etc. These are advantageously integrated into a mould and contain relevant data with regard to the mould, a manufacturing process, the used materials, etc. These means for storage are connected via defined interfaces to the injection moulding machine and if required to further apparatus. The interfaces are designed such that they may be applied in a varied manner. It is thus possible for example to design several moulds for an existing machine, with a defined interface. These moulds accordingly comprise a corresponding interface.

The moulds contain means for storing information. All data relevant to the manufacturing data are stored on these. This is determined numerically or by way of tests prior to or during the production process. At the sane time this data is not fixed but may be changed according to requirement in a manner such that e.g. certain experience values are taken into account. If during the production a change ill the manufacturing process is necessary the relevant data is brought up to date when required, actively connected interfaces of the mould and injection moulding machines released, the mould removed from the injection moulding machine and replaced by another which likewise comprises an actively connected corresponding interface.

The interfaces for the transfer of media advantageously comprise self-sealing couplings. These are designed in a manner such that the interfaces may be separated and connected without significant loss of media.

On inserting a mould into an injection moulding machine the interfaces of the mould and the machine are actively connected. E.g. all relevant data is transmitted from the means for storing data to the injection moulding machine in a manner such that this is optimally adapted to the mould. At the same time e.g. volume flows of the coolant, the temperature of the heating elements, the closing pressure of the machine, cycle times, injection parameters, etc. are transmitted. The means for storing data may also or alternatively when required consist of a microprocessor which e.g. monitors the values of sensors or operates control variables. The relevant data is advantageously transmitted as digital signals. A corresponding device may also be used for safeguarding the production process in that for example safety functions are monitored and carried out. For example it is possible to monitor service variables which determine when the mould requires maintenance (for example the number of cycles, etc.) More than one interface may be used in a machine.

The invention disclosed here is in particular suitable for inverter moulds as they are for example used with multi-component injection moulding. In particular with a stack inverter device one exploits the possibility of halving machine locking forces in the normal single and multi-component stack operation. In contrast to the conventional manufacture in the two-component stack operation the closure force pressures are centrally distributed and not out-of-centre as with the conventional manufacture. By way of this there results an improved quality, lower stresses as well as no temperature mixing, on account of the possibilities of the different temperature supplies, e.g. warm at the top, cold at the bottom; generally there is a considerable improvement in the quality. Further possibilities exist in assembly injection moulding.

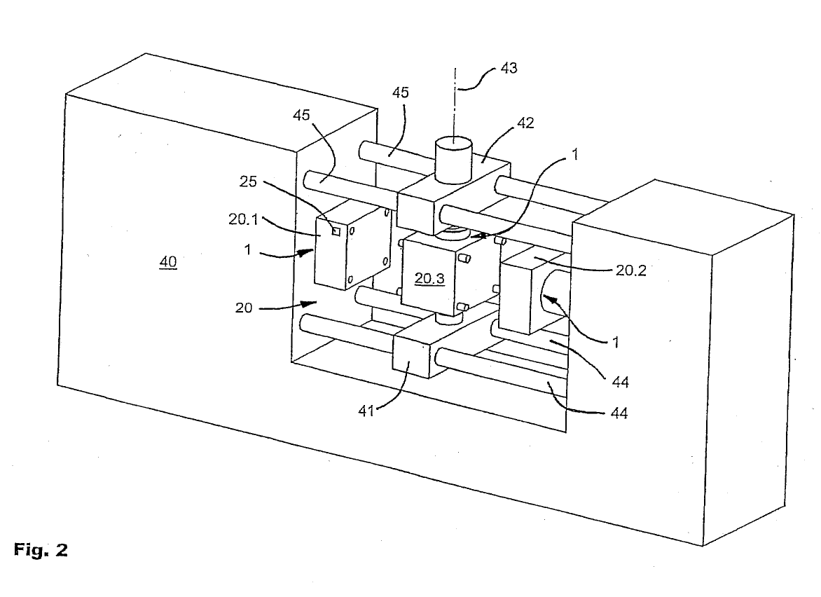

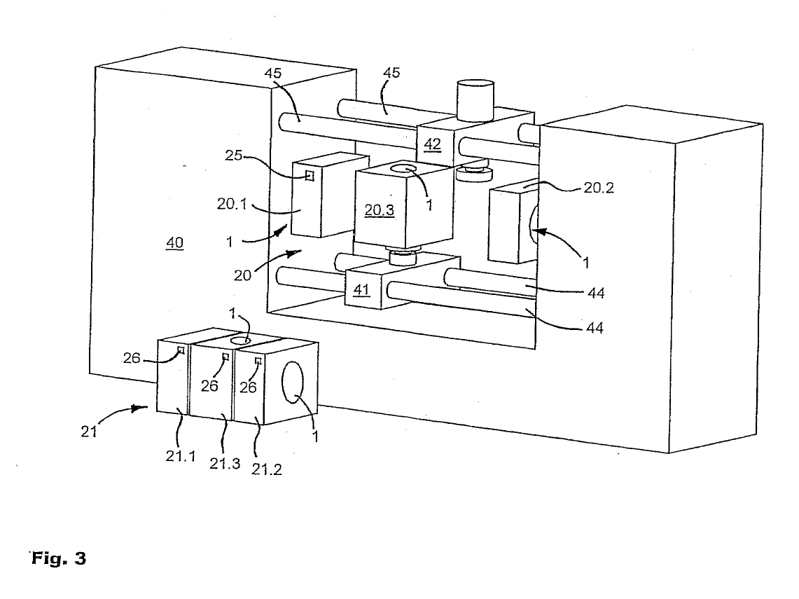

In one stack e.g. a part is manufactured, transported into the second one and led through the inverter means and by closing the machine the assembly is carried out. An additional possibility is cube technology with four or more sides (cf. FIGS. 2 and 3). With this, during an injection cycle—parts are ejected and e.g. sorted in a cavitational manner. With this first station first material, fourth station—removal, automatically via ejection and vacuum removal—further possibility in the stack inverter system as injection blowing version—injection mould, fist station, second station blowing, third station premould, fourth station blowing so that the capacity may be doubled.

Amongst other things the invention disclosed here offers the possibility of retracting the mould after the manufacture until production maturity is reached. At the same time, in an advantageous manner, all relevant data (machine data, peripheral data—that is to say mould temperature apparatus, hot channel temperatures, air, hydraulics, end switches, etc.) is stored in a chip, a data bank is set up, the information deposited in a data bank, with a further mould the possibility of designing the mould according to the modular settings so that when the mould is completed it may be provided with a chip. The tool recognition takes place e.g. by way of a coding system in the form of a chip or a coding plug for transmission from the tool to the inverter system and machine. All parameters may be automatically set on re-exchanging the mould e.g. into the inverter device. This means the mould change takes place in a relatively short time, since all parameters are connected and set on insertion of the mould in the inverter system.

The invention is hereinafter explained in more detail by way of the subsequent figures. There are shown in:

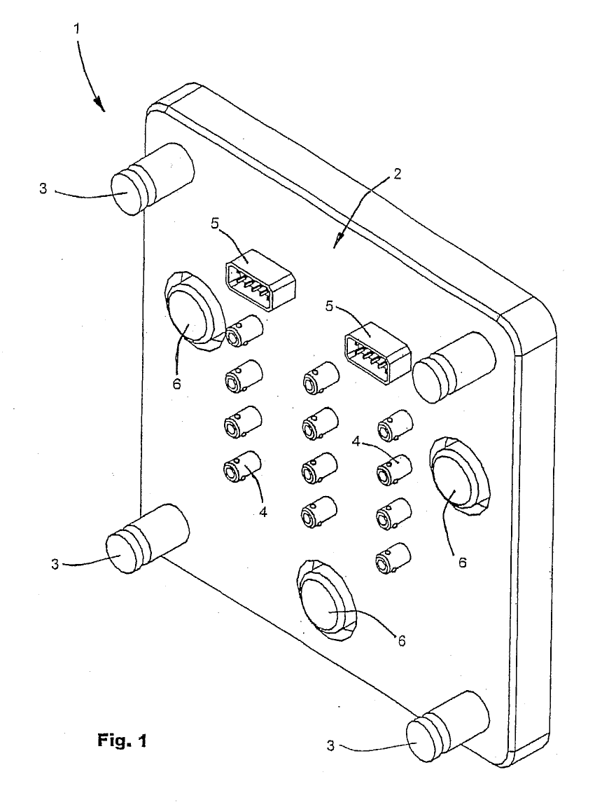

FIG. 1 schematically, a standardised interface part,

FIG. 2 schematically, an injection moulding machine with a mould,

FIG. 3 schematically, an injection moulding machine with two moulds.

FIG. 1 by way of example shows a standardised interface 1 (interface part). This interface part 1 serves amongst other things for an exchange of media and data between a mould 20 and an injection moulding machine 40 (cf. FIGS. 2 and 3). The interface part 1 has a standardised arrangement of interaction means 2 and positioning means 3. The interaction means 2 serve amongst other things for creating an active connection between a mould 20 and an injection moulding machine 40. They consist here of self-sealing couplings 4 which are arranged in a manner such that they match with corresponding counterparts, e.g. on several moulds.

Apart from the couplings 4 one may also recognise electrical connections, here in the form of plug connections 5. These plug collections 5 are likewise arranged in a manner such that they match with corresponding counterparts on more than one mould or machine. The plug connections serve for the energy supply and for the data exchange between means for storing and/or processing data, sensor means, etc. in a mould or an injection moulding machine. When required they serve for the identification of the mould.

The interaction means 2 are e.g. arranged and formed on one side of the injection moulding machine in a manner such that not all connections need to come into contact with each actively connectable mould. Certain interaction means may temporarily not be in operation, depending of the present actively connected mould. By way of a suitable arrangement one guarantees a high degree of flexibility.

The interface part 1 here also comprises means for transmitting mechanical energy. With the shown embodiment form it is the case of three circularly round surfaces which are movably arranged by way of an actuator (not shown in more detail). These means 6 become actively connected to corresponding counterparts and transmit mechanical energy between the injection moulding machine 40 and the mould 20. Other active connection means for the transmission of mechnical energy (e.g. in the form of shaft couplings) may accordingly be realised.

The positioning means 3 here are designed as a cylindrical peg with a groove. The positioning means 3 one the one hand serve for positioning a mould 20 with respect to an injection moulding machine 40 as well as on the other hand for positioning the corresponding interaction means 2 of two interfaces 1. The positioning means 3 furthermore serve for the releasable holding of a mould in an injection moulding machine.

The interface part 1 may for example also be designed as an independent module and comprise interaction means 2 which e.g. are fastened on a base plate.

FIG. 2 schematically shows an injection moulding machine 40 with a three-part inverter mould 20. The mould 20 consists here of a first side part 20.1, of a second side part 20.2 and a middle part 20.3. The middle part 20.3 is arranged between the two side parts 20.1, 20.2 and in the closed condition corresponds with these. The middle part 20.3 on a lower 41 and on an upper cross-member 42 is rotatably mounted about an axis 43 in a manner such that e.g. injection moulding parts of several components may be manufactured. The lower cross-member 42 is displaceably mounted along two lower bars and the upper cross-member 42 along two upper bars 45. The cross-members 41, 42 are preferably displaced by way of a hydraulic drive (not shown in more detail). The cross-members 41, 42 may be locked with respect to the bars 44, 45. In order to simplify the installation and removal of the mould 20, in particular of the middle part 20.3, the cross-members 41, 42 are movable independently of one another (cf. FIG. 3).

Between the side pats 20.1, 20.2 and the injection moulding machine 40 there are arranged interfaces (interface parts) within the context of the description of FIG. 1, which ensure an active connection between the side parts 20.1, 20.2 and the injection moulding machine. The middle part 20.3 of the mould 20 is likewise actively connected to at least one of the cross-members 41, 42 via at least one interface 1 in the context of the description of FIG. 1. The interface parts serve amongst other things for the exchange of media (not shown in more detail) between the mould 20 and the injection moulding machine. At least one of the mould parts 20.1, 20.2, 20.3 here comprises means for storing information 25. With these means it is preferably the case of an integrated circuit which on requirement may also be coupled to a microprocessor. The means for storing information 25 is connected via an interface 1 to the injection moulding machine 40 so that an exchange of data is possible. The means for storing information 25 informs the injection moulding machine for example of the condition of the mould 20, delivers parameters or relevant data on the current process, earlier processes, etc. The interface part 1 is configured in a manner such that it is actively connectable to several tools. The means for storing information 25 here e.g. as a module is fixedly integrated into the mould 20.

In particular on transmission of media to the middle part 20.3 of the mould 20 it is necessary to overcome a rotational movement. The transmission of media is therefore effected preferably coaxially via sealing connections. Further means for storing information may be integrated into other parts when required. The exchange of information between the injection moulding machine 40 and the mould 20 may also be effected in other ways, e.g. via radio.

FIG. 3 schematically shows the injection moulding machine 40 according to FIG. 1. One may recognise a first mould 20 consisting of the two side parts 20.1, 20.2 and the middle part 20.3. To be seen is a situation shortly before the exchange of the mould 20 with the mould 21. For this purpose the upper cross-member 42 is displaced along the upper bars 45 relative to the lower cross-member 41 in a manner such that the middle part 20.3 may be removed. The interface 1 which actively connects the cross-member 42 to the middle part 20.3 is designed or arranged in a manner such that a corresponding relative movement is permitted. This for example may be achieved by designing and arranging the interaction means accordingly.

The first and the second mould 20, 21 at suitable locations comprise interfaces 1 according to the description of FIG. 1 which are actively connectable to corresponding interfaces of the injection moulding machine. At the same time it is not necessary for the mould 20 to use the same interaction means of the interface 1 of the injection moulding machine 40 as the mould 21, although these are arranged in the same interface 1. The mould 20 comprises a means for storing information 25 in the first side pall 20.1. In contrast to this the mould 21 comprises means for storing and processing information 26 in the middle part 21.3 and in the side parts 21.1, 21.2. The means for storing and processing information 26 via interaction means 2 integrated in the interfaces 1 are connected to the injection moulding machine 40 and/or further apparatus. The means for storing and processing information may on requirement also be used for activating separate display means, etc. which for example are attached to one of the parts 20.1, 20.2, 20.3 of the mould 20.

1. An injection moulding mould (20) with at least two mould halves (20.1, 20.2, 20.3) for use in an injection moulding machine (40), characterised in that at least one of the mould halves (20.1, 20.2, 20.3) comprises a means for storing information (25, 26) with respect to the injection moulding mould (20), the injection moulding machine (40), one or more manufacturing processes or the materials to be processed.

2. An injection moulding mould (20) according to patent claim 1, characterised in that the means for storing information (25, 26) is designed in a manner such that with a change of the production process it serves for storing the relevant condition variables of the injection moulding mould (20) and/or of the injection moulding machine (40) so that this data with a re-exchange of the injection moulding mould (20) serves for setting the parameters specific to the production.

3. An injection moulding mould (20) according to one of the patent claims 1 or 2, characterised in that the means for storing information (25, 26) is designed in a manner such that it serves for storing information which previously has been evaluated numerically or by way of tests or during the production process.

4. An injection moulding mould (20) according to one of the preceding patent claims, characterised in that the means for storing information (25, 26) serves for the identification of the injection moulding mould (20).

5. An injection moulding mould (20) according to one of the preceding patent claims, characterised in that the means for storing information (25, 26) comprises a microprocessor which serves for monitoring control variables or sensors.

6. An injection moulding mould (20) according to one of the preceding patent claims, characterised in that the means for storing information (25, 26) is a chip.

7. An injection moulding mould (20) according to one of the preceding patent claims, characterised in that the injection moulding mould (20) comprises a standardised interface (1) for connection to all injection moulding machine (40).

8. An injection moulding mould (20) according to patent claim 6, characterised in that the standardised interface (1) comprises positioning means (3) for the releasable holding of a mould half (20.1, 20.2, 20.3)

9. An injection moulding machine (40) characterised by a standardised interface (1) which is suitable for the connection of an injection moulding mould (20) according to one of the patent claims 7 or 8.

10. An injection moulding machine (40) according to patent claim 9, characterised in that the injection moulding machine (40) comprises means which serve for reading out data specific to production from a means for storing information (25, 26) in an injection moulding mould (20).
